(19) United States
(12) Patent Application Publication
(10) Pub. No.: US 2005/0223566 A1
(43) Pub. Date: Oct. 13, 2005

(54) Rotary mowing member having a universal nut set for connecting a transmission shaft

(76) Inventor: Donald Joe Sullivan, Sandwich, IL (US)

Correspondence Address: BACON & THOMAS, PLLC, 625 SLATERS LANE, FOURTH FLOOR, ALEXANDRIA, VA, 22314, US

(21) Appl. No.: 10/819,160

(22) Filed: Apr. 7, 2004

(51) Int. Cl. A01D 34/00

(52) U.S. Cl. 30/276; 56/12.7

(57) ABSTRACT

A rotary mowing member having a universal nut set for connecting a transmission shaft comprises a mowing rotary member provided with an axial screw hole and a nut set consisting of a plurality of converter nuts. Each of the converter nuts has a screwed outer wall and a screwed inner hole, and thereby it can be secured within the screw hole of the mowing rotary member. The inner hole of each of the converter nuts can retain a transmission shaft of a lawn mower. The inner caliber of the converter nuts varies over the converter nuts for matching lawn mowers of different transmission shafts.

### BACKGROUND OF THE INVENTION

(a) Field of the Invention

The present invention relates to coupling mechanisms for connecting the transmission shaft and the rotary mowing member of a lawn mower, more particularly to a rotary mowing member having a universal nut set for connecting a transmission shaft.

(b) Description of the Prior Art

Lawn mowers based on principles of straight shaft and bump feed of the prior art, such as those disclosed by U.S. Pat. No. 5433006 and 5836227, comprise a rotary power source and a rotary mowing member. The caliber of the transmission shaft of the rotary power source and a connecting hole on the top surface of the rotary mowing member varies over lawn mowers of different manufacturers. Therefore, a rotary power source and a rotary mowing member respectively from different manufacturers cannot usually be connected. If a consumer switches to a rotary power source of different brand, he or she has to replace the rotary mowing member at the same time, which is not economical.

### SUMMARY OF THE INVENTION

Accordingly, the primary objective of the present invention is to provide a rotary mowing member having a universal nut set for connecting a transmission shaft, whereby lawn mower of various specifications can be connected. The rotary mowing member having a universal nut set for connecting a transmission shaft comprises a mowing rotary member provided with an axial screw hole and a nut set consisting of a plurality of converter nuts. Each of the converter nuts has a screwed outer wall and a screwed inner hole, and thereby it can be secured within the screw hole of the mowing rotary member. The inner hole of each of the converter nuts can retain a transmission shaft of a lawn mower. The inner caliber of the converter nuts varies over the converter nuts for matching lawn mowers of different transmission shafts.

It is a further objective of the present invention that, when a transmission shaft is provided with a screw hole at a free end thereof, a bolt is partially secured in said screw hole so that one of said converter nuts can be connected to said bolt.

The various objects and advantages of the present invention will be more readily understood from the following detailed description when read in conjunction with the appended drawings.

### BRIEF DESCRIPTION OF THE DRAWINGS

FIG. 1 is a perspective view of a nut set accordingly to the present invention.

FIG. 2 illustrates the first preferred embodiment of the present invention.

FIG. 3 illustrates the second preferred embodiment of the present invention.

FIG. 4 is a cross-sectional view of the second preferred embodiment according to the present invention.

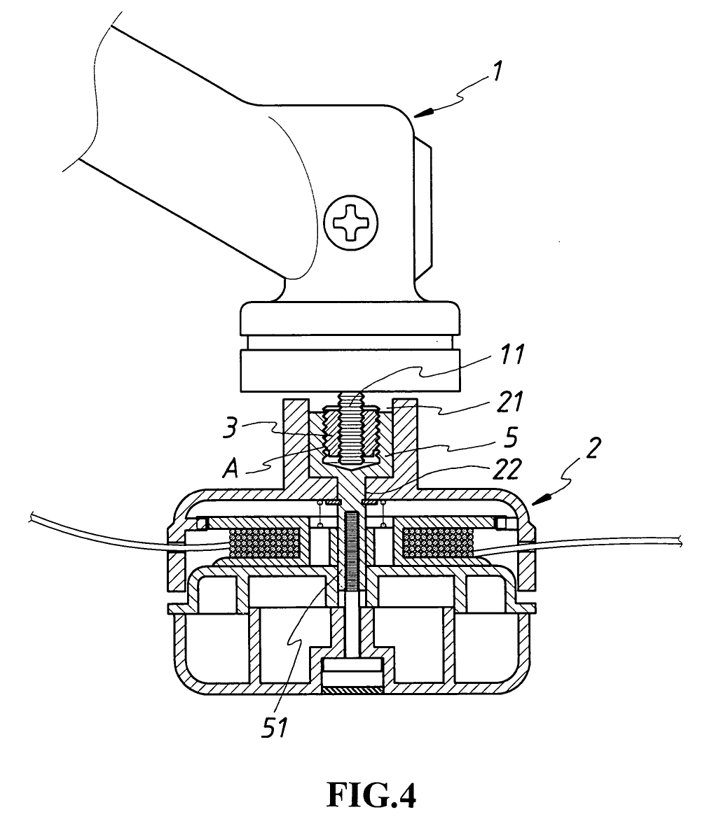

FIG. 5 illustrates a lawn mower coupled with a mowing rotary member using the present invention.

FIG. 6 is an exploded perspective view of the second preferred embodiment according to the present invention.

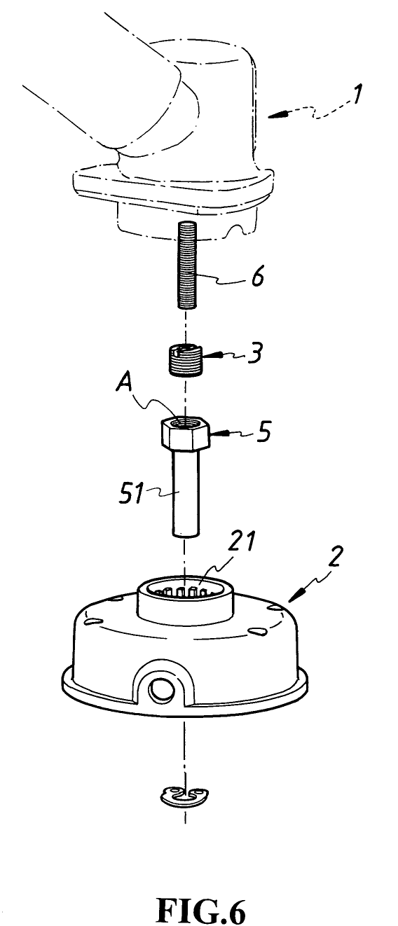

### DETAILED DESCRIPTION OF THE PREFERRED EMBODIMENTS

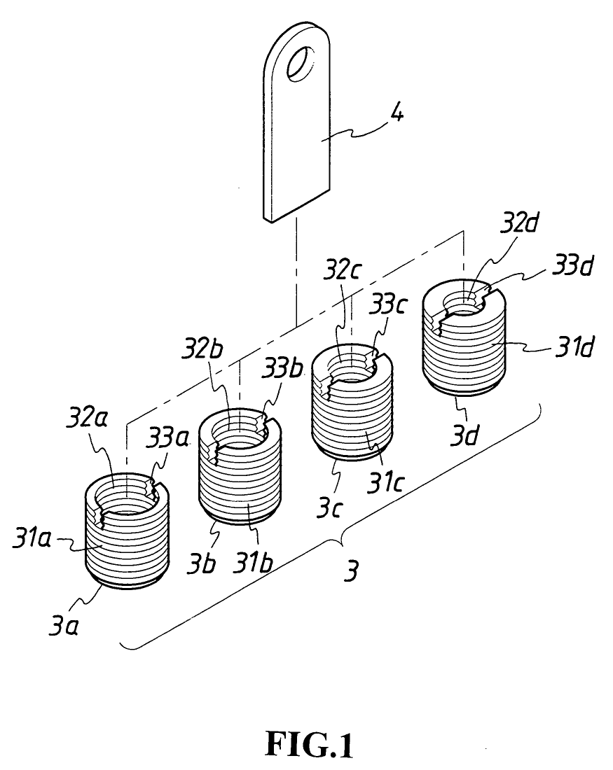

A rotary mowing member having a universal nut set for connecting a transmission shaft according to the present invention comprises a nut set 3 having a plurality of converter nuts (for example, 3a, 3b, 3c and 3d in FIG. 1) for engaging a screw hole A on the axis of a mowing rotary member 2 and the transmission shaft 11 of a lawn mower 1.

The nut set 3 comprises a plurality of converter nuts 3a, 3b, 3c and 3d, which are hollow tubular object having the same outer diameter and different inner diameters. The outer surfaces of the converter nuts 3a, 3b, 3c and 3d are provided with outer screw threads 31a, 31b, 31c and 31d. Respectively provided with screw threads, the inner hollow spaces of the converter nuts 3a, 3b, 3c and 3d form inner lock holes 32a, 32b, 32c and 32d. The upper ends of the converter nuts 3a, 3b, 3c and 3d are respectively provided with transverse notches 33a, 33b, 33c and 33d.

To connect the lawn mower I and the mowing rotary member 2, a driving plate 4 is used to engage with the notch (33a, 33b, 33c or 33d) of a selected converter nut (3a, 3b, 3c or 3d) for screwing the converter nut (3a, 3b, 3c or 3d) into the screw hole A of the mowing rotary member 2. The transmission shaft 11 of a lawn mower 1 is then coupled with the inner lock hole (32a, 32b, 32c or 32d) of the converter nut (3a, 3b, 3c or 3d).

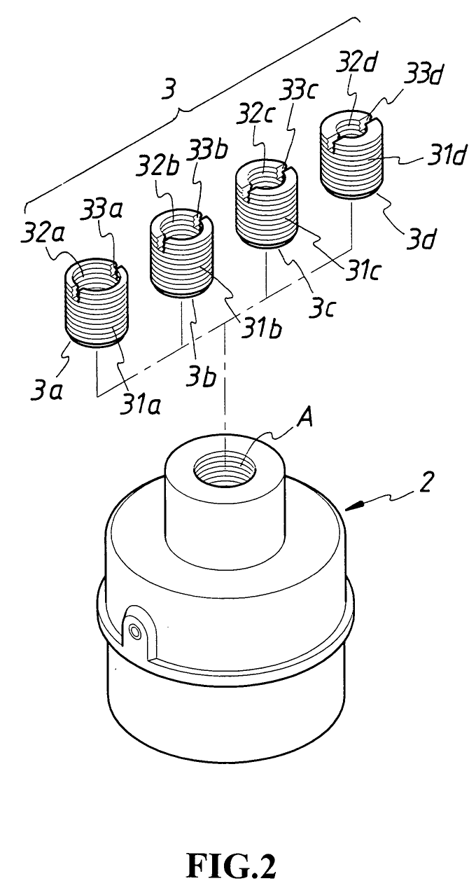

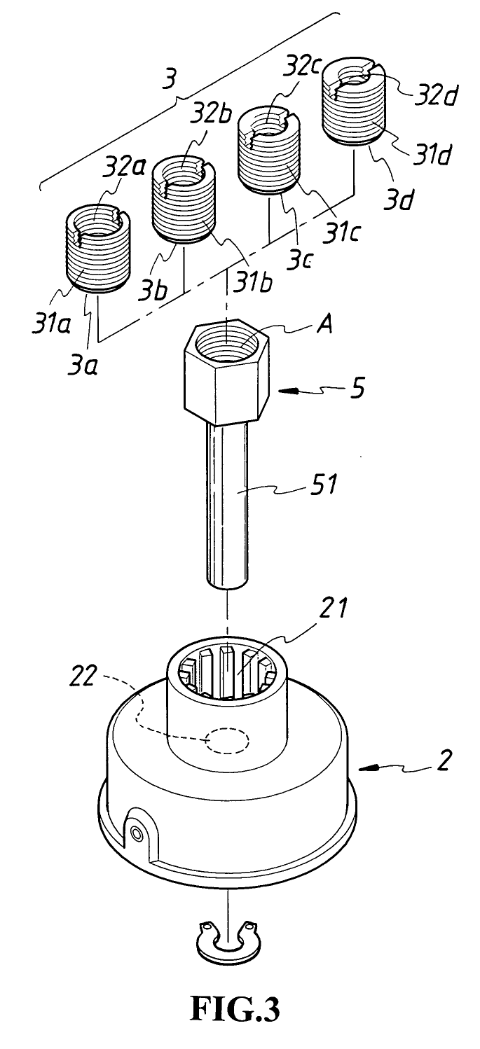

Further, the screw hole A of the mowing rotary member 2 for securing a converter nut (3a, 3b, 3c or 3d) of the nut set 3 can be one of the following configurations. The first preferred embodiment, as shown in FIG. 2, is a mowing rotary member 2 that has a screw hole A integrally formed on the top surface thereof. The caliber of the screw hole A is large enough to secure the converter nuts 3a, 3b, 3c and 3d by coupling with the screw threads 31a, 31b, 31c and 31d. The second preferred embodiment, as shown in FIG. 3, the top portion of the mowing rotary member 2 is provided with a polygonal receptacle hole 21. The bottom end of the receptacle hole 21 is provided with a through hole 22. A polygonal lock base 5 can be coupled within the receptacle hole 21. The top surface of the lock base 5 is provided with a screw hole A of large caliber for securing either one of converter nuts 3a, 3b, 3c and 3d by engaging the screwed inner wall of the screw hole A with the outer screw threads 31a, 31b, 31c or 31d of converter nuts 3a, 3b, 3c or 3d. The lock base 5 further includes an axial rod 51 extended from the bottom thereof and capable of being inserted into the through hole 22 of the mowing rotary member 2. The axial rod 51 goes through the through hole 22 and is secured on the other side of the mowing rotary member 2 by a C-shaped retaining ring or a flexible lock ring.

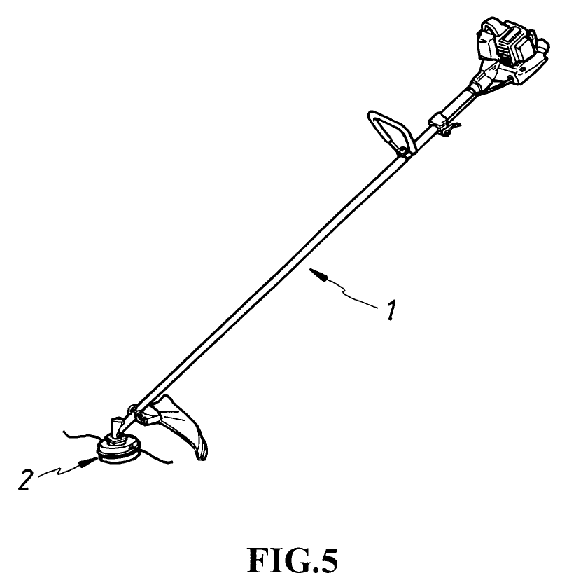

Therefore, a mowing rotary member 2 selected from aforesaid preferred embodiments utilizes a screw hole A to secure any one of the nut set 3. The converter nuts 3a, 3b, 3c and 3d of the nut set 3 respectively having various inner lock holes 32a, 32b, 32c and 32d can be selected so that the transmission shaft 11 of a lawn mower 1 can be connected to the mowing rotary member 2. Further, the nut set 3 is for providing a connection interface for a mowing rotary member 2 and a lawn mower 1. To fit transmission shafts of various calibers, the inner lock holes 32a, 32b, 32c and 32d of respectively the converter nuts 3a, 3b, 3c and 3d are of various calibers corresponding to commonly seen transmission shafts of lawn mowers 1 in the market. The outer screw threads 31a, 31b, 31c and 31d of respectively the converter nuts 3a, 3b, 3c and 3d can be coupled with the screw hole A of a mowing rotary member 2. Thereby, the mowing rotary member 2 of the present invention can be mounted on lawn mowers of various specifications in the market, as shown in FIG. 5.

Further, if a transmission shaft 11 of a lawn mower 1 does not have extended section and, instead, has a screw hole at the lower terminal, a bolt 6 is inserted in the screw hole to form an extended section for connecting the mowing rotary member 2. Since the specifications of the screw holes vary, a plurality of bolts 6 is chosen to form a bolt set.

The cutting members of the mowing rotary member 2 of the present invention is not restricted to flexible cutting lines shown in the figures, and they also can be blades, thin plates, etc.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A rotary mowing member having a universal nut set for connecting a transmission shaft, comprising:
a mowing rotary member having a screw hole at an upper end of an axial portion thereof; and
a nut set consisting of a plurality of converter nuts having outer calibers approximately the same as the caliber of said screw hole of said mowing rotary member, said converter nuts being substantially hollow tubular objects identical in outer caliber and different in inner caliber, each of said converter nuts being provided with an outer screw thread on an outer cylindrical wall thereof, each of said converter nuts being provided with an inner screw thread on an inner cylindrical wall thereof;
whereby each of said converter nuts can be secured within said screw hole of said mowing rotary member, and whereby said inner hole of each of said converter nuts can be coupled with a transmission shaft of an external rotary power source.

2. The rotary mowing member having a universal nut set for connecting a transmission shaft of claim 1 wherein said converter nuts have identical outer screw threads for matching said screw hole on said mowing rotary member, and wherein said converter nuts have inner lock holes of different calibers respectively corresponding to transmission shafts of different calibers.

3. The rotary mowing member having a universal nut set for connecting a transmission shaft of claim 1 wherein

4. The rotary mowing member having a universal nut set for connecting a transmission shaft of claim 1 wherein said mowing rotary member is further provided with a receptacle hole capable of being coupled with a lock base.

5. The rotary mowing member having a universal nut set for connecting a transmission shaft of claim 4 wherein said lock base further includes an axial rod extended from a bottom end thereof, and wherein said axial rod can go through the axis of said mowing rotary member and be secured by a means selected from C-shaped retaining ring and resilient lock ring.

6. The rotary mowing member having a universal nut set for connecting a transmission shaft of claim 1 wherein an upper end of each of said converter nuts is provided with a transverse notch for receiving a driving plate.

7. The rotary mowing member having a universal nut set for connecting a transmission shaft of claim 1 wherein said transmission shaft is provided with a screw hole at a free end thereof and a bolt is partially secured in said screw hole so that one of said converter nuts can be connected to said bolt.

8. The rotary mowing member having a universal nut set for connecting a transmission shaft of claim 7 wherein a plurality of said bolts having a variety of calibers are provided so that transmission shafts having various screw holes can be connected to said mowing rotary member.
